(19) United States
(12) Patent Application Publication
(10) Pub. No.: US 2026/0264523 A1
(43) Pub. Date: Sep. 10, 2026

(54) METHOD AND SYSTEM FOR ADJUSTING AN ALIGNMENT OF A HEAD-MOUNTED DEVICE WITHIN A MOVING VEHICLE

(71) Applicant: EVERYSIGHT LTD., Haifa (IL)

(72) Inventor: Ari ABRAMSON, Haifa (IL)

(73) Assignee: EVERYSIGHT LTD., Haifa (IL)

(21) Appl. No.: 19/661,770

(22) Filed: Apr. 29, 2026

Related U.S. Application Data
(63) Continuation of application No. PCT/IL2023/051114, filed on Oct. 29, 2023.

(51) Int. Cl. B60K 35/90; B60K 35/23

(52) U.S. Cl. CPC B60K 35/90; B60K 35/23

(57) ABSTRACT

A method and a system for adjusting an alignment of a head mounted display (HMD) worn by a user in a moving vehicle, relative to an inertial frame of reference are provided herein. The system includes: an inertial sensor coupled to the HMD configured to measure dynamics of the HMD, relative to the inertial frame of reference; an inertial sensor coupled to the vehicle configured to measure position and orientation of the vehicle, relative to the inertial frame of reference; and a computer processor configured to: obtain kinematic parameters associated with a movement of the vehicle relative to the inertial frame of reference; determine occurrence of a specific kinematic event that meet predefined kinematic behavior of the vehicle, based on kinematic parameters; and upon detection of such occurrence, compare readings of the inertial sensor coupled to the HMD and the inertial sensor coupled to the vehicle, to yield alignment parameters.

### CROSS REFERENCE TO RELATED APPLICATIONS

This application is a continuation of International Application No. PCT/IL2023/051114, filed Oct. 29, 2023.

### FIELD OF THE INVENTION

The present invention relates generally to head mounted devices and more specifically for adjusting an alignment of same.

### BACKGROUND OF THE INVENTION

Prior to the background of the invention being set forth, it may be helpful to provide definitions of certain terms that will be used hereinafter.

The term “inertial measurement unit (IMU)” as used herein is defined as any device that measures and reports a body's specific force, angular rate, and sometimes the orientation of the body, using a combination of accelerometers, gyroscopes, and sometimes magnetometers. An IMU can be used for an inertial navigation system (INS).

The term “Head-Mounted Device” as used herein is defined as any device that is mounted on the head of a human user. One private case is a Head-Mounted Display which is a display device, worn on the head or as part of a helmet that has a small display optic in front of one or each eye. An HMD has many uses including gaming, aviation, engineering, and medicine. Some HMDs are combined with inertial measurements units (IMUs). Optical head-mounted displays (OHMD) are wearable display that can reflect projected images and allows a user to see through it.

Using an HMD sometimes requires the HMD to be aligned with the scene, meaning that the position and orientation of the HMD will be known within the inertial frame of reference of the scene. When using the HMD on a moving platform such as a vehicle, it is desirable that the alignment is with the frame of reference of the vehicle

In order to achieve alignment, measurements from various sensors and particularly IMUs are taken. Then, calculation resulting in relative position and/or orientation can be achieved using well know geometric methods. Practically speaking, the alignment between two or more IMU sensors can be calculated relative to their common inertial frame of reference. The challenge is usually to use simple and cheap IMUs without compromising the accuracy of the alignment.

An HMD typically uses simple IMUs that tend to exhibit a drift over time in the calculated position and/or orientation, even during a single session of use. It may be required to perform some adjustment to their alignment with the reference frame in order to allow using them.

### SUMMARY OF THE INVENTION

Embodiments of the present invention provide a method and a system for adjusting an alignment of a head mounted display (HMD) worn by a user in a vehicle moving relative to an inertial frame of reference. The system may include: at least one inertial sensor coupled to the HMD and configured to measure dynamics of the HMD relative to the inertial frame of reference; at least one inertial sensor coupled to the vehicle and configured to measure dynamics of the vehicle relative to the inertial frame of reference; and a computer processor configured to: obtain kinematic parameters associated with a movement of the vehicle relative to the inertial frame of reference; determine an occurrence of a specific kinematic event that meet predefined kinematic behavior of the vehicle, based on the kinematic parameters; and upon detection of the occurrence of the specific kinematic event, compare the readings of the at least one inertial sensor coupled to the HMD and the at least one inertial sensor coupled to the vehicle, to yield alignment parameters.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating a system in accordance with some embodiments of the present invention;

FIG. 2 is a block diagram on a vehicle illustrating an aspect in accordance with embodiments of the present invention; and

FIG. 3 is a high-level flowchart illustrating a method in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing” “computing” “calculating” “determining” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

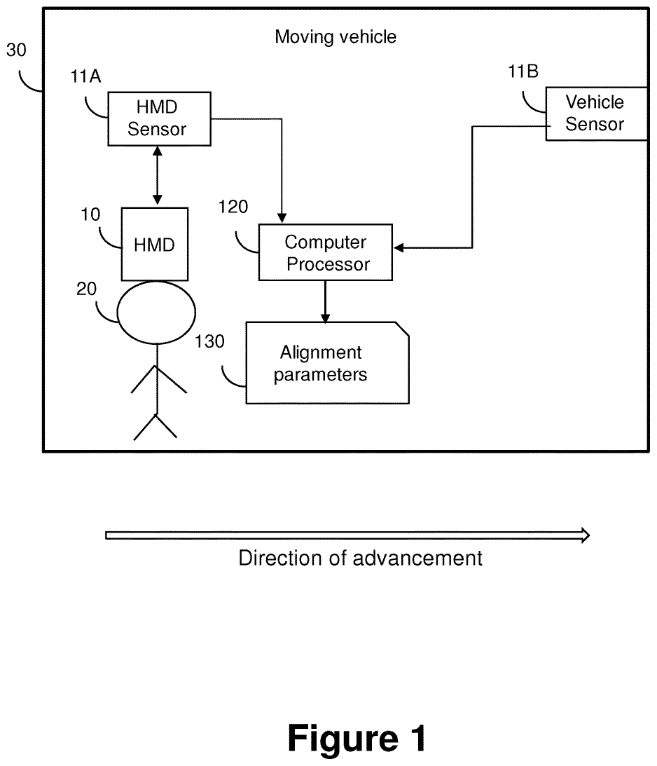

FIG. 1 is a block diagram illustrating a system for adjusting an alignment of a head mounted display 10 (HMD) worn by a user 20 in a vehicle 30 moving relative to an inertial frame of reference. The system may include: at least one inertial sensor 11A coupled to the HMD and configured to measure position and/or orientation of the HMD relative to the inertial frame of reference and at least one inertial sensor 11B coupled to the vehicle 30 and configured to measure position and/or orientation of the vehicle relative to the inertial frame of reference.

The system may further include: a computer processor 120 configured to: obtain kinematic parameters associated with a movement of the vehicle relative to the inertial frame of reference; determine an occurrence of a specific kinematic event that meet predefined kinematic behavior of the vehicle, based on the kinematic parameters; and upon detection of the occurrence of the specific kinematic event, compare the readings of the at least one inertial sensor coupled to the HMD and the at least one inertial sensor coupled to the vehicle, to yield alignment parameters 130.

According to some embodiments of the present invention, the alignment parameters may include vectoral data indicating the vectoral difference between the readings of the at least one inertial sensor coupled to the HMD and the readings of the at least one inertial sensor coupled to the vehicle. Mathematically speaking, the vectoral difference may include relative rotation and/or translation of the two frames of reference, the one of the HMD and the one of the vehicle.

According to some embodiments of the present invention, the specific kinematic event may include acceleration and/or deceleration. As the two sensors are experiencing similar physical condition (forces) and so, by comparing the readings it is possible to compute the alignment that caused the different readings (if any).

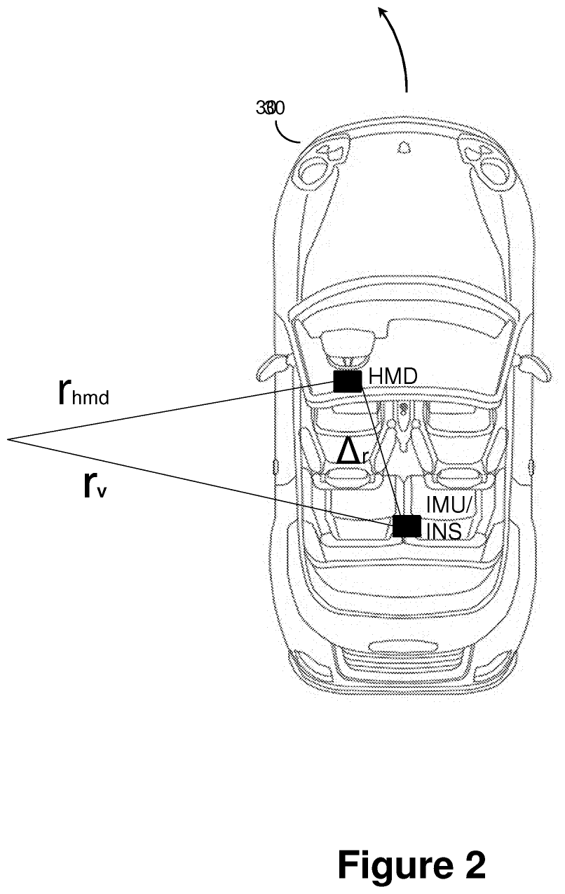

FIG. 2 is a diagram showing the relative locations and the spatial interrelation between the sensor on the HMD (indicated HMD) and the sensor that is secured to (and assumed to be aligned with) vehicle 30 and indicated IMU/INS.

Specifically, the mathematical relationship between the two is discussed below in detail and provides further enablement of for some embodiments of the present invention.

The rotation matrix between the vehicle coordinates frame and the HMD coordinate frame,

$${R}_{v}^{h m d} ,$$

may be obtained by equation (1) below:

$${R}_{v}^{h m d} = A {{\hat{R}}_{I}^{h m d} ( {R}_{I}^{v} )}^{- 1} \qquad ( 1 )$$

where:

$${R}_{I}^{v}$$

is the rotation between the inertial reference frame and the vehicle frame, as measured by the (higher grade) IMU\INS mounted on the vehicle and

$${\hat{R}}_{I}^{h m d}$$

is the computed rotation between the inertial reference frame and the HMD based on the IMU that is mounted on the HMD. As the IMU is typically of a low grade, this term might slowly drift over time and also it's initial value might have an arbitrary rotation error around the gravity. The alignment matrix A compensates for these two error sources.

The computed rotation

$${\hat{R}}_{I}^{h m d}$$

might drift along time and we need to recalculate the correction alignment between this drifted rotation and the true HMD frame-A.

The vehicle acceleration, as measured by the vehicle's IMU/INS (assuming a constant rotation rate) follows equation (2) below:

$${a}_{v} = {R}_{I}^{v} ( g + {a}_{linear} ) + {ω}_{v} \times {ω}_{v} \times {r}_{v} \qquad ( 2 )$$

where g is the gravitational acceleration vector in the inertial frame, aₗᵢₙₑₐᵣ is the linear kinematic acceleration term of the vehicle as measured in the inertial frame and

ωᵥ is the rotation rate of the vehicle with respect to the inertial frame (as measured by the vehicle's frame).

rᵥ is the vehicle rotation radius as measured in the vehicle frame (see FIG. 2). Therefore, the term ωᵥ×ωᵥ×rᵥ describes the centrifugal acceleration term due to rotation of the vehicle with respect to the inertial frame.

Comparing the accelerations as measured by the HMD, a_{hmd}, with the acceleration measured by the IMU/INS mounted on the vehicle, aᵥ, it may be possible to obtain equation (3) below:

$${a}_{h m d} = {R}_{v}^{h m d} {a}_{v} + {R}_{v}^{h m d} ( {ω}_{v} \times {ω}_{v} \times Δ r ) + {a}_{k} \qquad ( 3 )$$

where ωᵥ is the rotation rate of the vehicle with respect to the inertial frame (as measured in the vehicle's frame); and
Δr is the relative position of the HMD with respect to the vehicle IMU/INS (see figure below), as measured in the vehicle coordinate frame (usually denoted as the lever arm). This term may be calibrated, and the effect of typical HMD movements around its nominal position within the vehicle has only a minor impact.

The last term, aₖ, is the residual kinematic acceleration of the HMD with respect to the vehicle frame, as measured in the HMD frame (due to the relative dynamics of the HMD with respect to the car frame). This term cannot be neglected for a short time. However, as the HMD does stay inside the vehicle, this term averages to zero for long time periods.

To summarize the above, under dynamics (linear and/or rotational), comparing the measured accelerations as in (3) and substituting in (1) one can update the alignment matrix to compensate for the HMD orientation error.

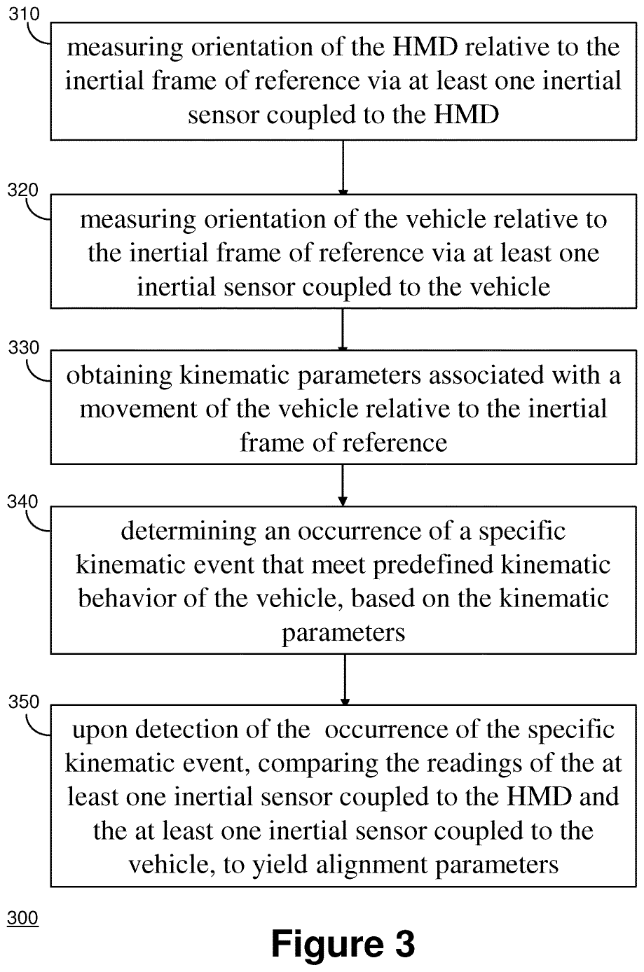

FIG. 3 is a high-level flowchart illustrating a method in accordance with embodiments of the present invention. Method 300 of adjusting an alignment of a head mounted display (HMD) worn by a user in a vehicle on a road moving relative to an inertial frame of reference, is provided herein. Method 300 may include the following steps: measuring orientation of the HMD relative to the inertial frame of reference via at least one inertial sensor coupled to the HMD 310; measuring orientation of the vehicle relative to the inertial frame of reference via at least one inertial sensor coupled to the vehicle 320; obtaining kinematic parameters associated with a movement of the vehicle relative to the inertial frame of reference 330; determining an occurrence of a specific kinematic event that meet predefined kinematic behavior of the vehicle, based on the kinematic parameters 340; and upon detection of the occurrence of the specific kinematic event, comparing the readings of the at least one inertial sensor coupled to the HMD and the at least one inertial sensor coupled to the vehicle, to yield alignment parameters 350.

According to some embodiments of the present invention, the alignment parameters comprise rotation data indicating the vectoral difference between the readings of the at least one inertial sensor coupled to the HMD and the at least one inertial sensor coupled to the vehicle.

According to some embodiments of the present invention, the specific kinematic event comprises an acceleration of the vehicle responsive to an action of a driver of the vehicle. The action of the driver of the vehicle may result in acceleration or deceleration (negative sign acceleration which may include acceleration or deceleration due to vehicle turn.

According to some embodiments of the present invention, the specific kinematic event comprises braking of the vehicle responsive to an action of a driver of the vehicle.

According to some embodiments of the present invention, the specific kinematic event comprises movement of the vehicle along a known direction over a specific time interval.

According to some embodiments of the present invention, the movement of the vehicle along a known direction comprises movement along a straight road.

According to some embodiments of the present invention, the movement of the vehicle along a known direction is detected by monitoring GPS readings.

According to some embodiments of the present invention, the specific kinematic event may include movement of the vehicle along a known direction over a specific time interval. In accordance with this use case, it is assumed that the HMD is not experiencing any external forces (zero acceleration). Rather, the assumption in this use case is that the wearer of the HMD is looking at the same direction as the movement of the vehicle on average. While this embodiment may be less accurate in general due to the heuristic it involves, (e.g., the wearer is the driver and therefore is mostly looking at the direction of the advancement of the vehicle).

This embodiment may be useful in case there is no acceleration of the vehicle for a long period of time, e.g., during cruise control. However, on average it is reasonable to assume that at least when the wearer of the HMD is the driver of the vehicle, he or she looks at the advancement direction of the vehicle most of driving time.

According to some embodiments of the present invention, the specific kinematic event further may include an assessment of a likelihood of a wearer of the HMD looking at a direction of advancement of the vehicle.

According to some embodiments of the present invention the movement of the vehicle along a known direction comprises movement along a straight road.

According to some embodiments of the present invention the movement of the vehicle along a known direction is detected by monitoring GPS readings, or based on a higher grade IMU that is mounted on the vehicle.

According to some embodiments, the present invention may be implemented on a non-transitory computer readable medium for adjusting an alignment of a head mounted display (HMD) worn by a user in a vehicle moving on a road relative to an inertial frame of reference, the computer readable medium comprising a set of instructions that, when executed, cause at least one computer processor to: measure orientation of the HMD relative to the inertial frame of reference via at least one inertial sensor coupled to the HMD; measure orientation of the vehicle relative to the inertial frame of reference via at least one inertial sensor coupled to the vehicle; obtain kinematic parameters associated with a movement of the vehicle relative to the inertial frame of reference; determine an occurrence of a specific kinematic event that meet predefined kinematic behavior of the vehicle, based on the kinematic parameters; and upon detection of the occurrence of the specific kinematic event, compare the readings of the at least one inertial sensor coupled to the HMD and the at least one inertial sensor coupled to the vehicle, to yield alignment parameters.

In order to implement method 300 according to some embodiments of the present invention, a computer processor may receive instructions and data from a read-only memory or a random-access memory or both. At least one of aforementioned steps may be performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++, Python or the like and conventional procedural programming languages, such as the “C” programming language or similar programming languages. The program code may execute entirely on the user's computer, partly on the user's computer, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purposes only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional elements.

It is to be understood that where the claims or specification refer to “a” or “an” element, such reference is not be construed that there is only one of that elements.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system for adjusting an alignment of a head mounted display (HMD) worn by a user in a vehicle moving relative to an inertial frame of reference, the system comprising:
at least one inertial sensor coupled to the HMD and configured to measure position and/or orientation of the HMD relative to the inertial frame of reference;
at least one inertial sensor coupled to the vehicle and configured to measure position and/or orientation of the vehicle relative to the inertial frame of reference; and
a computer processor configured to:
obtain kinematic parameters associated with a movement of the vehicle relative to the inertial frame of reference;
determine an occurrence of a specific kinematic event that meet predefined kinematic behavior of the vehicle, based on the kinematic parameters; and
upon detection of the occurrence of the specific kinematic event, compare readings of the at least one inertial sensor coupled to the HMD and the at least one inertial sensor coupled to the vehicle, to yield alignment parameters.

2. The system according to claim 1, wherein the alignment parameters comprise rotation data indicating a vectoral difference between the readings of the at least one inertial sensor coupled to the HMD and the readings of the at least one inertial sensor coupled to the vehicle.

3. The system according to claim 1, wherein the specific kinematic event comprises an acceleration and/or deceleration.

4. The system according to claim 3, wherein the acceleration and/or deceleration is centrifugal acceleration/deceleration related to turns of the vehicle.

5. The system according to claim 1, wherein the specific kinematic event comprises movement of the vehicle along a known direction over a specific time interval.

6. The system according to claim 1, wherein the specific kinematic event further comprises an assessment of a likelihood of a wearer of the HMD looking at a direction of advancement of the vehicle.

7. The system according to claim 4, wherein the movement of the vehicle along a known direction comprises movement along a straight road.

8. The system according to claim 4, wherein the movement of the vehicle along a known direction is detected by monitoring GPS readings.

9. A method of adjusting an alignment of a head mounted display (HMD) worn by a user in a vehicle moving on a road relative to an inertial frame of reference, the method comprising:
measuring orientation of the HMD relative to the inertial frame of reference via at least one inertial sensor coupled to the HMD;
measuring orientation of the vehicle relative to the inertial frame of reference via at least one inertial sensor coupled to the vehicle;
obtaining kinematic parameters associated with a movement of the vehicle relative to the inertial frame of reference;
determining an occurrence of a specific kinematic event that meet predefined kinematic behavior of the vehicle, based on the kinematic parameters; and
upon detection of the occurrence of the specific kinematic event, comparing readings of the at least one inertial sensor coupled to the HMD and the at least one inertial sensor coupled to the vehicle, to yield alignment parameters.

10. The method according to claim 9, wherein the alignment parameters comprise rotation data indicating a vectoral difference between the readings of the at least one inertial sensor coupled to the HMD and the at least one inertial sensor coupled to the vehicle.

11. The method according to claim 9, wherein the specific kinematic event comprises an acceleration and/or deceleration of the vehicle responsive to an action of a driver of the vehicle.

12. The method according to claim 11, wherein the acceleration and/or deceleration is centrifugal acceleration/deceleration related to turns of the vehicle.

13. The method according to claim 9, wherein the specific kinematic event comprises braking of the vehicle responsive to an action of a driver of the vehicle.

14. The method according to claim 9, wherein the specific kinematic event comprises movement of the vehicle along a known direction over a specific time interval.

15. The method according to claim 14, wherein the movement of the vehicle along a known direction comprises movement along a straight road.

16. The method according to claim 14, wherein the movement of the vehicle along a known direction is detected by monitoring GPS readings.

17. A non-transitory computer readable medium for adjusting an alignment of a head mounted display (HMD) worn by a user in a vehicle moving on a road relative to an inertial frame of reference, the computer readable medium comprising a set of instructions that, when executed, cause at least one computer processor to:
measure orientation of the HMD relative to the inertial frame of reference via at least one inertial sensor coupled to the HMD;
measure orientation of the vehicle relative to the inertial frame of reference via at least one inertial sensor coupled to the vehicle;
obtain kinematic parameters associated with a movement of the vehicle relative to the inertial frame of reference;
determine an occurrence of a specific kinematic event that meets predefined kinematic behavior of the vehicle, based on the kinematic parameters; and
upon detection of the occurrence of the specific kinematic event, compare readings of the at least one inertial sensor coupled to the HMD and the at least one inertial sensor coupled to the vehicle, to yield alignment parameters.

18. The non-transitory computer readable medium according to claim 17, wherein the alignment parameters comprise rotation data indicating a vectoral difference between the readings of the at least one inertial sensor coupled to the HMD and the at least one inertial sensor coupled to the vehicle.

19. The non-transitory computer readable medium according to claim 17, wherein the specific kinematic event comprises an acceleration and/or deceleration of the vehicle responsive to an action of a driver of the vehicle.

20. The non-transitory computer readable medium according to claim 19, wherein the acceleration and/or deceleration is centrifugal acceleration/deceleration related to turns of the vehicle.
